(19) United States
(12) Patent Application Publication
(10) Pub. No.: US 2012/0292100 A1
(43) Pub. Date: Nov. 22, 2012

(54) ACCESSIBLE INDIRECT ENTRY CABLE GLAND

(75) Inventor: David G. Thomas, Peachtree City, GA (US)

(73) Assignee: SANY HEAVY EQUIPMENT, USA R&D INSTITUTE, Peachtree City, GA (US)

(21) Appl. No.: 13/112,724

(22) Filed: May 20, 2011

(51) Int. Cl. H02G 3/18

(52) U.S. Cl. 174/652

(57) ABSTRACT

In one aspect of the present invention, an accessible indirect entry cable gland has a collar having a first end, an opposite, second end, and a first bore adapted for receiving a cable having one or more electrical conductors from the first end thereof and passing the cable through the second end thereof into a flameproof enclosure, a flame-resistant bushing filling a first part of the first bore of the collar at the second end thereof and adapted for passing the cable therethrough and holding the cable in place, and a cap having a first end and an opposite, second end, and a second bore adapted for receiving the cable from the first end thereof and passing the cable having one or more electrical conductors through the second end thereof into the collar. The accessible indirect entry cable gland further has an o-ring positioned adjacent to the first end of the cap and gripping a jacket of the cable, and a clamp adapted for mating with the first end of the cap so that the clamp and the cap can be fastened and re-fastened together after being un-fastened, wherein, when the clamp and the cap are fastened together, the clamp exerts a pressure on the o-ring against the jacket of the cable, thereby to retain the cable against movement with respect to the accessible indirect entry cable gland.

### FIELD OF THE INVENTION

The present invention relates to a cable gland, and more particularly, to an accessible indirect entry cable gland that has an accessible terminal chamber for permitting a cable having one or more electrical conductors to enter a flameproof enclosure, where the accessible terminal chamber is filled with a flame-resistant compound for keeping the one or more electrical conductors of the cable separated.

### BACKGROUND OF THE INVENTION

A flameproof enclosure is used when electrical components, such as switches and contactors, may cause sparks or arcing in normal operation conditions. A flameproof enclosure is constructed so that it will contain an explosion of flammable gas or vapor and will not permit ignition of a surrounding explosive atmosphere. Flameproof enclosures are widely used in mining equipment and other types of equipment used in hazardous environments. Electrical cables can be brought into a flameproof enclosure directly or indirectly. In the case of direct cable entry, electrical cables are brought into a flameproof enclosure via a cable entry gland.

There are currently two types of indirect entry. The first type involves installing a terminal chamber on the outside of the flameproof enclosure. Electrical terminals are mounted inside the terminal chamber, and an insulating bushing is provided for each electrical conductor that enters through the walls of the flameproof enclosure. This type of entry cable gland is costly and the external terminal box requires additional space. The second type involves a cable gland assembly that does not permit access to the terminal area of the assembly. This type of entry cable gland cannot be re-used after each repair. Therefore, this is a costly approach throughout the lifecycle of the equipment, since the cable gland assembly needs to be replaced whenever a repair is needed.

Therefore, a heretofore unaddressed need exists in the art to address the aforementioned deficiencies and inadequacies.

### SUMMARY OF THE INVENTION

The present invention, in one aspect, relates to an accessible indirect entry cable gland assembly for permitting a cable having one or more electrical conductors to enter a flameproof enclosure. In one embodiment, the accessible indirect entry cable gland has a collar having a first end, an opposite, second end, and a first bore adapted for receiving the cable from the first end thereof and passing the cable through the second end thereof into the flameproof enclosure; a flame-resistant bushing filling a first part of the first bore of the collar at the second end thereof and adapted for passing the cable therethrough and holding the cable in place; and a cap having a first end and an opposite, second end, and a second bore adapted for receiving the cable from the first end thereof and passing the cable through the second end thereof into the collar.

The second end of the cap is adapted for mating with the first end of the collar so that the cap and the collar can be fastened and re-fastened together after being un-fastened, where a second part of the first bore of the collar at the first end thereof and the second bore of the cap form a terminal chamber when the cap and the collar are fastened together, and the terminal chamber is accessible when the cap and the collar are un-fastened.

Further, the accessible indirect entry cable gland has an o-ring positioned adjacent to the first end of the cap and gripping a jacket of the electrical cable; and a clamp adapted for mating with the first end of the cap so that the clamp and the cap can be fastened and re-fastened together after being un-fastened, where, when the clamp and the cap are fastened together, the clamp exerts a pressure on the o-ring against the jacket of the cable having one or more electrical conductors, thereby to retain the cable having one or more electrical conductors against movement with respect to the accessible indirect entry cable gland.

In one embodiment, the cap and the collar are fastened together by mating female and male threads on the second end of the cap and the first end of the collar, respectively, or vice versa.

In one embodiment, the clamp and the cap are fastened together by mating male and female threads on the clamp and the first end of the cap, respectively, or vice versa.

In one embodiment, the flame-resistant bushing comprises a flame-resistant epoxy.

In one embodiment, the collar and the cap are machined metal parts.

In one embodiment, the clamp is a machined metal part.

In another aspect, the present invention relates to an accessible indirect entry cable gland for permitting a cable having one or more electrical conductors to enter a flameproof enclosure. In one embodiment, the accessible indirect entry cable gland includes a collar having a first end and an opposite, second end, and a first bore adapted for receiving the cable from the first end thereof and passing the one or more electrical conductors through the second end thereof into the flameproof enclosure; a flame-resistant bushing filling a first part of the first bore of the collar at the second end thereof and adapted for passing the one or more electrical conductors therethrough and holding the conductors in place; a cap having a first end and an opposite, second end, and a second bore adapted for receiving the cable from the first end thereof and passing the conductors through the second end thereof into the collar, where the second end of the cap is adapted for mating with the first end of the collar so that the cap and the collar can be fastened and re-fastened together after being un-fastened, wherein, when the cap and the collar are fastened together, the second bore of the cap and a second part of the first bore of the collar at the first end thereof form a terminal chamber, and wherein the terminal chamber is accessible when the cap and the collar are un-fastened; an o-ring positioned adjacent to the first end of the cap and gripping a jacket of the cable; and a clamp adapted for mating with the first end of the cap so that the clamp and the cap can be fastened and re-fastened together after being un-fastened, where, when the clamp and cap are fastened together, the clamp exerts a pressure on the o-ring against the jacket of the cable, thereby to retain the cable against movement with respect to the accessible indirect entry cable gland.

In one embodiment, the cap and the collar are fastened together by mating female and male threads on the second end of the cap and the first end of the collar, respectively, or vice versa.

In one embodiment, the clamp and the cap are fastened together by mating male and female threads on the clamp and the first end of the cap, respectively, or vice versa.

In one embodiment, the flame-resistant bushing comprises a flame-resistant epoxy.

In one embodiment, the collar and the cap are machined metal parts.

In one embodiment, the clamp is a machined metal part.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment, and wherein:

FIG. 1 shows a cross sectional view of an accessible indirect entry cable gland assembly according to one embodiment of the present invention; and

FIG. 2 shows a three-dimensional view of an assembled accessible indirect entry cable gland assembly according to one embodiment of the present invention.

### DETAILED DESCRIPTION OF THE INVENTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom”, “upper” or “top,” and “front” or “back” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the term “plurality” means a number greater than one.

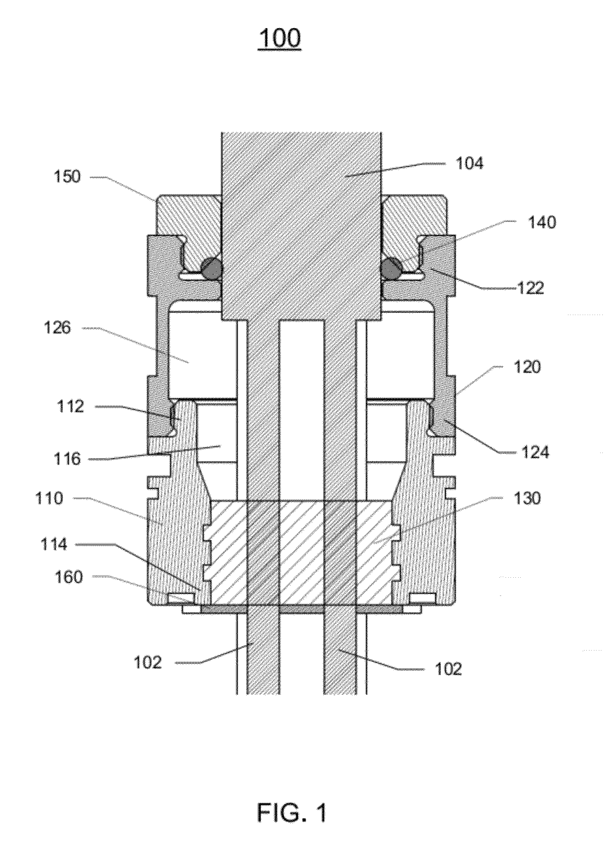

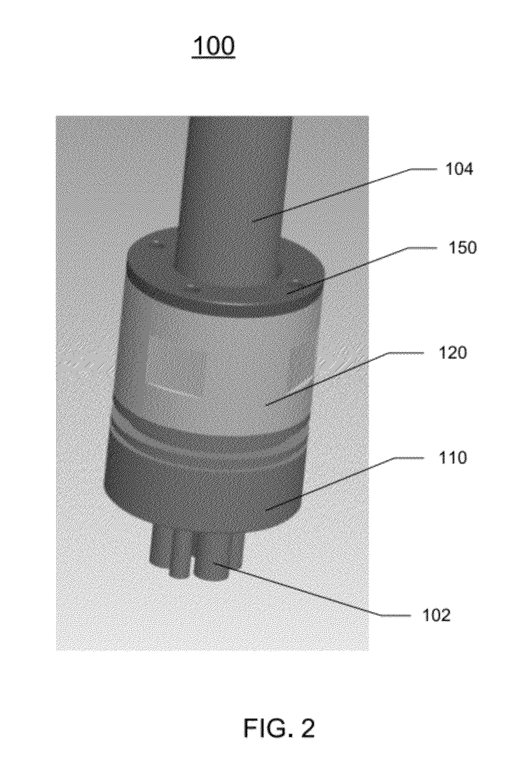

The description will be made as to the embodiments of the present invention in conjunction with the accompanying drawings in FIGS. 1 and 2. In accordance with the purposes of this invention, as embodied and broadly described herein, this invention, in one aspect, relates to an accessible indirect entry cable gland assembly.

FIG. 1 shows a cross sectional view of an accessible indirect entry cable gland assembly 100 for permitting a cable 104 having one or more electrical conductors 102 to enter a flameproof enclosure according to one embodiment of the present invention. The accessible indirect entry cable gland assembly 100 includes a collar 110 having a first end 112 and an opposite, second end 114. The collar 110 further has a first bore 116 adapted for receiving the cable 104 having one or more electrical conductors 102 from the first end 112 thereof and passing the cable 104 having one or more electrical conductors 102 through the second end 114 thereof into the flameproof enclosure. The accessible indirect entry cable gland assembly 100 further includes a flame-resistant bushing 130. The flame-resistant bushing 130 fills a first part of the first bore 116 of the collar 110 at the second end 114 thereof and is adapted for passing the cable 104 having one or more electrical conductors 102 therethrough and holding the cable 104 having one or more electrical conductors 102 in place.

The accessible indirect entry cable gland assembly 100 further includes a cap 120. The cap 120 has a first end 122 and an opposite, second end 124. The cap 120 further has a second bore 126 adapted for receiving the cable having one or more electrical conductors 102 from the first end 122 thereof and passing the cable having one or more electrical conductors 102 through the second end 124 thereof into the collar 110. The second end 124 of the cap 120 is adapted for mating with the first end 112 of the collar 110 so that the cap 120 and the collar 110 can be fastened and re-fastened together after being un-fastened. A second part of the first bore 116 of the collar 110 at the first end thereof and the second bore 126 of the cap 120 form a terminal chamber when the cap 120 and the collar 110 are fastened together. The terminal chamber is accessible when the cap 120 and the collar 110 are unfastened for repair, so that conductors can be re-attached by splicing or other means. After the repair is done, the cap 120 and the collar 110 can be re-fastened together and the accessible indirect entry cable gland assembly 100 can be re-used.

In one embodiment, the accessible indirect entry cable gland assembly 100 further includes an o-ring 140 and a clamp 150. The o-ring 140 is positioned adjacent to the first end 122 of the cap 120 and grips a jacket 104 of the cable 104 having one or more electrical conductors 102. The clamp 150 is adapted for mating with the first end 122 of the cap 120 so that the clamp 150 and the cap 120 can be fastened and re-fastened together after being un-fastened. When the clamp 150 and the cap 120 are fastened together, the clamp 150 exerts a pressure on the o-ring 140 against the jacket 104 of the cable having one or more electrical conductors 102, thereby to retain the cable having one or more electrical conductors 102 against movement with respect to the accessible indirect entry cable gland 100. The o-ring 140 also provides protection against moisture and dust ingression into the terminal chamber.

In one embodiment, the cap 120 and the collar 110 are fastened together by mating male and female threads on the first end 112 of the collar 110 and the second end 124 of the cap 120, respectively, or vice versa. The clamp 150 and the cap 120 are fastened together by mating male and female threads on the first end 122 of the cap 120 and the clamp 150, respectively, or vice versa. Each of the collar 110, the cap 120, and clamp 150 can be machined or molded parts, and can be made of metal or other flame-resistant materials. In other embodiments, the collar 110 and the cap 120 can be fastened together by other means, such as clamping means. The cap 120 and the clamp 150 can also be fastened together by other means, such as clamping means.

In one embodiment, the flame-resistant bushing 130 is formed by a flame-resistant epoxy filled in the first part of the first bore 116 of the collar 110 at the second end 114 thereof when the cable having one or more electrical conductors 102 are in place. The flame-resistant epoxy keeps the cable having one or more electrical conductors 102 apart from each other. The flame-resistant epoxy is filled in after a temporary adhesive 160 is applied to the second end 114 of the collar 110 to hold the cable 104 having one or more electrical conductors 102 in place. Once the electrical cables 102 are fixed by the flame-resistant epoxy, the accessible indirect entry cable gland assembly 100 can be assembled by threading the collar 110 and the cap 120 together, and threading the clamp 150 and the cap 120 together. FIG. 2 shows an assembled indirect cable gland assembly 100 according to one embodiment of the present invention.

The accessible indirect entry cable gland assembly 100 described above provides an end-user the ability to re-use the cable gland by having an accessible terminal chamber, and therefore saves cost through the lifecycle of the equipment that utilizes the cable gland assembly.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An accessible indirect entry cable gland assembly for permitting a cable having one or more electrical conductors to enter a flameproof enclosure, comprising:
(a) a collar having a first end and an opposite, second end, and a first bore adapted for receiving the cable having one or more electrical conductors from the first end thereof and passing the cable through the second end thereof into the flameproof enclosure;
(b) a flame-resistant bushing filling a first part of the first bore of the collar at the second end thereof and adapted for passing the cable therethrough and holding the cable in place; and
(c) a cap having a first end and an opposite, second end, and a second bore adapted for receiving the cable from the first end thereof and passing the cable through the second end thereof into the collar;
wherein the second end of the cap is adapted for mating with the first end of the collar so that the cap and the collar can be fastened and re-fastened together after being un-fastened, wherein a second part of the first bore of the collar at the first end thereof and the second bore of the cap form a terminal chamber when the cap and the collar are fastened together, and wherein the terminal chamber is accessible when the cap and the collar are un-fastened.

2. The accessible indirect entry cable gland of claim 1, further comprising:
(a) an o-ring positioned adjacent to the first end of the cap and gripping a jacket of the cable having the one or more electrical cables; and
(b) a clamp adapted for mating with the first end of the cap so that the clamp and the cap can be fastened and re-fastened together after being un-fastened, wherein, when the clamp and the cap are fastened together, the clamp exerts a pressure on the o-ring against the jacket of the cable, thereby to retain the cable against movement with respect to the accessible indirect entry cable gland.

3. The accessible indirect entry cable gland of claim 1, wherein the cap and the collar are fastened together by mating female and male threads on the second end of the cap and the first end of the collar, respectively, or vice versa.

4. The accessible indirect entry cable gland of claim 2, wherein the clamp and the cap are fastened together by mating male and female threads on the clamp and the first end of the cap, respectively, or vice versa.

5. The accessible indirect entry cable gland of claim 1, wherein the flame-resistant bushing comprises a flame-resistant epoxy.

6. The accessible indirect entry cable gland of claim 3, wherein the collar and the cap are machined metal parts.

7. The accessible indirect entry cable gland of claim 4, wherein the clamp is a machined metal part.

8. An accessible indirect entry cable gland for permitting a cable having one or more electrical conductors to enter a flameproof enclosure, comprising:
(a) a collar having a first end and an opposite, second end, and a first bore adapted for receiving the cable having one or more electrical conductors from the first end thereof and passing the cable through the second end thereof into the flameproof enclosure;
(b) a flame-resistant bushing filling a first part of the first bore of the collar at the second end thereof and adapted for passing the cable therethrough and holding the cable in place;
(c) a cap having a first end and an opposite, second end, and a second bore adapted for receiving the cable having one or more electrical conductors from the first end thereof and passing the cable through the second end thereof into the collar, wherein the second end of the cap is adapted for mating with the first end of the collar so that the cap and the collar can be fastened and re-fastened together after being un-fastened, wherein, when the cap and the collar are fastened together, the second bore of the cap and a second part of the first bore of the collar at the first end thereof form a terminal chamber, and wherein the terminal chamber is accessible when the cap and the collar are un-fastened;
(d) an o-ring positioned adjacent to the first end of the cap and gripping a jacket of the cable having one or more electrical conductors; and
(e) a clamp adapted for mating with the first end of the cap so that the clamp and the cap can be fastened and re-fastened together after being un-fastened, wherein, when the clamp and cap are fastened together, the clamp exerts a pressure on the o-ring against the jacket of the cable having one or more electrical conductors, thereby to retain the cable having one or more electrical conductors against movement with respect to the accessible indirect entry cable gland.

9. The accessible indirect entry cable gland of claim 8, wherein the cap and the collar are fastened together by mating female and male threads on the second end of the cap and the first end of the collar, respectively, or vice versa.

10. The accessible indirect entry cable gland of claim 9, wherein the clamp and the cap are fastened together by mating male and female threads on the clamp and the first end of the cap, respectively, or vice versa.

11. The accessible indirect entry cable gland of claim 8, wherein the flame-resistant bushing comprises a flame-resistant epoxy.

12. The accessible indirect entry cable gland of claim 9, wherein the collar and the cap are machined metal parts.

13. The accessible indirect entry cable gland of claim 10, wherein the clamp is a machined metal part.
